(19) United States
(12) Patent Application Publication
(10) Pub. No.: US 2008/0026750 A1
(43) Pub. Date: Jan. 31, 2008

(54) Method and system for managing allocation of connection identifiers (CIDs) to a wireless device in a network

(76) Inventors: John M. Harris, Chicago, IL (US); Ronald T. Crocker, St. Charles, IL (US); Sania C. Irwin, Glen Ellyn, IL (US); Vijay G. Subramanian, Ranelagh (IE)

Correspondence Address: MOTOROLA, INC., 1303 EAST ALGONQUIN ROAD, IL01/3RD, SCHAUMBURG, IL, 60196, US

(21) Appl. No.: 11/494,120

(22) Filed: Jul. 27, 2006

(51) Int. Cl. H04Q 7/20

(52) U.S. Cl. 455/435.1

(57) ABSTRACT

A method for managing allocation of connection identifiers (CIDs) to a wireless device in a network is provided. The method comprises allocating a CID to at least first wireless device based on a predefined criteria. The CID is allocated for at least one service accessed by the wireless device. The CID includes predetermined bit locations. The predetermined bit locations includes first predetermined bit locations and second predetermined bit locations. Further, the method comprises instructing the at least first wireless device to be responsive to messages that contain predetermined bit locations from the CID.

### BACKGROUND OF THE INVENTION

The present invention relates to the field of wireless communication, and more particularly to a method and system for allocation of connection identifiers to wireless devices in a network.

Nowadays, various services, such as a voice service, a messaging service, and an internet service, are provided on wireless devices, for example a mobile phone. Providing the services consumes bandwidth in a network. The rate at which a wireless device receives data can depend on the available bandwidth. Further, the availability of the bandwidth is regulated by the government, and hence limited. Moreover, mass data transmission and reception at a wireless device (or a mobile phone) are in an example system governed by 802.16e standard by the Institute of Electrical Engineers (IEEE), or Third Generation Partnership Project 2 (3GPP2) phase 2, or Third Generation Partnership Project (3GPP) LTE. Identifications, referred to as connection identifiers (CIDs), are allocated to identify various devices in a network. Typically, all the bits of a CID need to transmitted to uniquely identify a particular wireless device. The transmission of all the bits of a CID consumes a significant amount of channel overhead in the network. This degrades the network performance by consuming significant capacity and increases the time required for the transmission.

In order to preserve system capacity, various methods have been proposed to identify transmissions to a particular wireless device. In one such method, the network can use only least significant bits (LSBs) of individual CIDs to communicate with wireless devices. In another such method, a base station in a network can allocate a CID with a lesser number of bits to a wireless device. Thereafter, the base station decides whether to use the reduced CID. In yet another such method, the CID is broken in two fields and the wireless device is informed of whether to use one or both of the fields to identify the wireless device.

However, the methods described above have one or more of the following limitations. The method of using only LSBs to identify a wireless device may not work if other wireless devices have the same LSBs. Thus, the wireless device may not be uniquely identified. Moreover, if a wireless device is allocated particular values in the LSBs then no other wireless device can be allocated CIDs with those particular values in the LSBs. This will limit the number of CIDs available for allocation, as the size of the CID is fixed. CIDs with more bits can solve the problem of a limited number of CIDs available for allocation, but such CIDs will consume more capacity of the network.

Further, the methods may not be used if a wireless device is receiving poor signal strength. In such an instance, a complete CID may have to be transmitted a number of times. This consumes greater power and system overhead. Furthermore, a wireless device may have to receive a CID frequently if the wireless device consumes services with a higher bit rate, receives data at frequent time intervals, and/or changes its location often. This would consume even more power and overhead in a network and degrade the network performance.

Hence, there is a need for a method to reduce channel overheads by managing allocation of the CID in such a way that the allocation maximizes the system performance benefit.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments, and to explain various principles and advantages, all in accordance with the present invention.

FIG. 1 illustrates a network in accordance with an embodiment of the present invention;

FIG. 2 illustrates a block diagram of a wireless device in a network in accordance with an embodiments of the present invention;

FIG. 3 illustrates a block diagram of a base transceiver station in a network in accordance with an embodiments of the present invention;

FIG. 4 illustrates a flow diagram depicting a method for managing allocation of connection identifiers (CID) to a wireless device in a network in accordance with an embodiment of the present invention; and

FIG. 5 is a graphical representation of packet offsets for a service accessed by the wireless devices in the network in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements, to help in improving an understanding of the embodiments of the present invention.

### DETAILED DESCRIPTION

Before describing in detail the particular method and system for managing allocation of connection identifiers (CIDs) to a wireless device in a network in accordance with various embodiments of the present invention, it should be observed that the present invention resides primarily in combinations of a method for managing allocation of connection identifiers (CIDs) to a wireless device in a network. Accordingly, the method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms “comprises,” “comprising,” or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The terms “includes” and/or “having”, as used herein, are defined as comprising.

Generally, an embodiment of the present invention encompasses a method for managing allocation of connection identifiers (CIDs) to a wireless device in a network. The network provides a plurality of services to the wireless devices. The method includes allocating a CID to at least one wireless device in the network based on predefined criteria. The CID is allocated for at least one service accessed by the at least one wireless device. The method also includes instructing the wireless devices to be responsive to messages that contain predetermined bit locations from the CID allocated to the wireless device.

Another embodiment of the present invention encompasses a wireless device capable of operating a network. The wireless device includes a receiver and a processor. The wireless device sends a request to the network to access a service provided by the network. The receiver is capable of receiving a set of instructions from the network. Thereafter, the processor enables the wireless device to respond to messages containing predetermined bit locations of the CID based on the set of instructions received from the network.

Yet another embodiment of the present invention encompasses a Base Transceiver System (BTS) capable of operating in a network and providing services to wireless devices in the network. The BTS includes a processor capable of allocating a connection identifier (CID) to a wireless device or a group of wireless devices in the network. The CID is allocated for at least one service accessed by the wireless device. A transmitter then instructs the wireless device or a group of wireless devices to be responsive to all messages containing predetermined bit locations in the destination field. The predetermined bit locations include first predetermined bit locations and second predetermined bit locations.

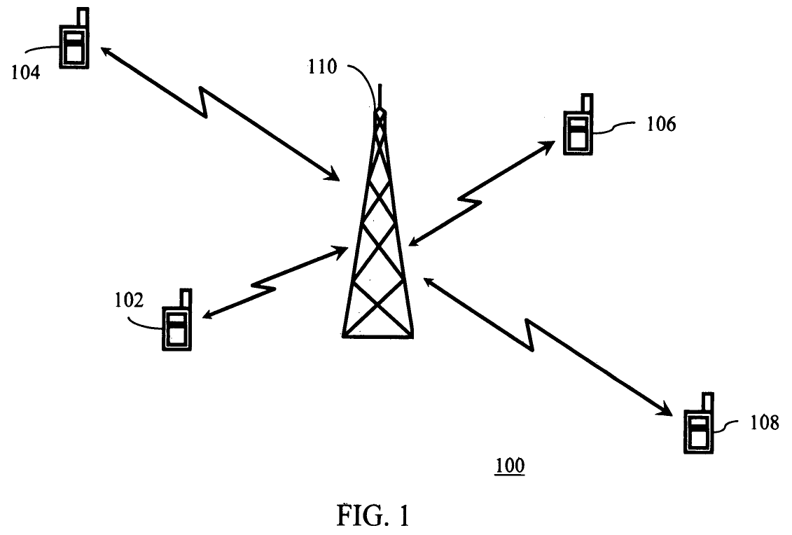

FIG. 1 illustrates a network 100 in which various embodiments of the present invention can be practiced. The network 100 includes a plurality of wireless devices 102, 104, 106, and 108 and a base transceiver station (BTS) 110. Examples of a wireless device include a Personal Digital Assistant (PDA), a mobile phone, a smart phone, a laptop, a set-top-box, a desktop computer, and so forth. The BTS 110 provides various services to the wireless devices 102, 104, 106, and 108. Examples of a service include an Internet service, a voice call service, a messaging service, and so forth. Hereinafter, the invention is described with reference to wireless device 102 for the sake of clarity. The wireless device 102 can send a request to the BTS 110 to access a service. Thereafter, the BTS 110 allocates a connection identifier (CID) to the wireless device 102, prior to enabling accessing to the service. The CID is a multi-bit string that identifies the connection, for a particular service, between the wireless device 102 and the BTS 110. While accessing the service, a plurality of data packets is transmitted to the wireless device 102. The CID is included in the plurality of data packets to enable the packets to identify and reach the wireless device 102.

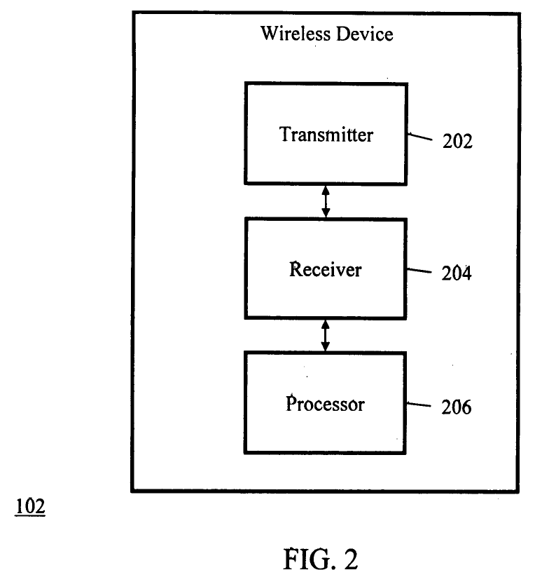

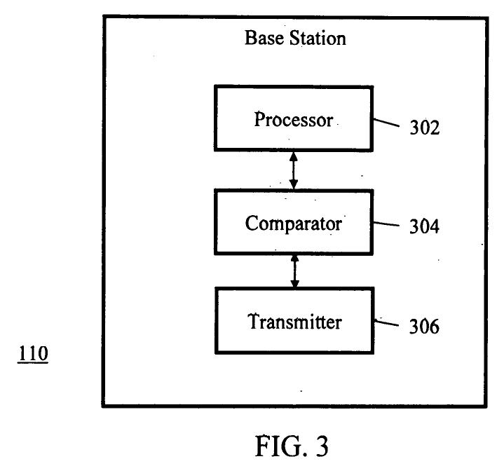

FIG. 2 illustrates a block diagram of the wireless device 102 in accordance with an embodiment of the present invention. The wireless device 102 includes a transmitter 202, a receiver 204, and a processor 206. The wireless device 102 sends a request to access a service in the network 100. A CID is allocated to the wireless device 102. The CID is a multi-bit string used to identify the wireless device 102 while the wireless device 102 accesses a service. The CID includes first predetermined bit locations and second predetermined bit locations. For example, the first predetermined bit locations can be some number of the Most Significant Bits (MSBs) and the second predetermined bit locations can be some number of the Least Significant Bits (LSBs). The receiver 204 can receive a set of inch cautions (instructions) from the network 100. The instructions are sent with the CID, which CID is allocated based on a predefined criteria. In various embodiments of the present invention, the predefined criteria may include a current frame offset for the service accessed by the wireless device 102 being equal to a pre-specified packet offset, a signal strength at the wireless device 102 being less than a pre-specified signal strength, and/or a rate of data traffic at the wireless device 102 being greater than a pre-specified signal strength. The predefined criteria are described in further detail in conjunction with FIG. 3. Further, the processor 206 interprets the instructions received by the wireless device 102. The instructions enable the wireless device 102 to be responsive to messages containing the predetermined bit locations of the CID. In an embodiment of the present invention, the transmitter 202 in the wireless device 102 sends the request to the BTS 110 to access the service in the network 100.

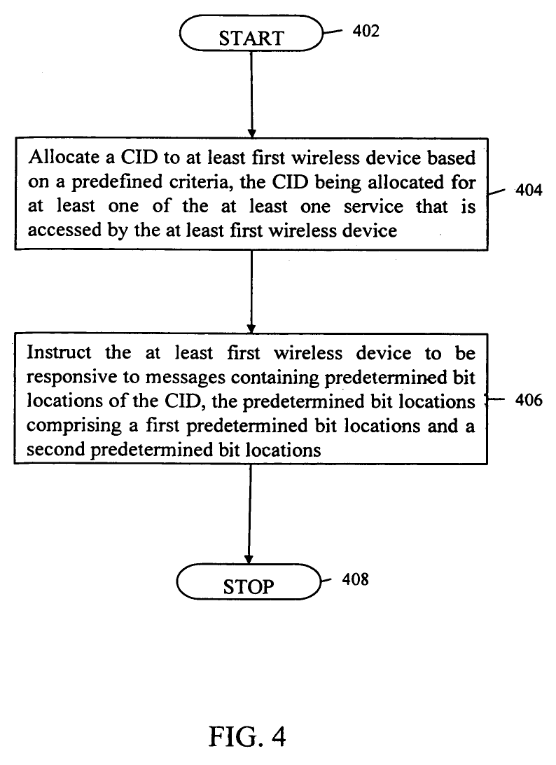

FIG. 3 illustrates a block diagram of the BTS 110 in the network 100 in accordance with an embodiment of the present invention. In one such embodiment, the network 100 can be a current sector of wireless devices in the network. The BTS 110 includes a processor 302, a comparator 304, and a transmitter 306. The BTS 110 receives a request from the wireless device 102 to access a service. Thereafter, the processor 302 allocates a CID to the wireless device 102. The CID is allocated to the wireless device 102 for every service that is accessed by the wireless device 102. The processor 302 allocates the CID based on a predefined criteria. Further, the comparator 304 compares the number of users in a group of wireless devices with a pre-specified threshold, the rate of data traffic at the wireless device 102 with a pre-specified rate of data traffic, the signal strength at the wireless device 102 with a pre-specified signal strength, and/or the current frame offset for the service at the wireless device 102 with a pre-specified packet offset. The comparison is explained in further detail in conjunction with FIG. 4. Based on the comparison, the transmitter 306 instructs the wireless device 102 to be responsive to messages that have predetermined bit locations of the CID. The instructions are sent to the wireless device 102 based on the results of the comparison. The predetermined bit locations include first predetermined bit locations and second predetermined bit locations. In an embodiment of the present invention, the first predetermined bit locations are some of the MSBs of the CID and the second predetermined bit locations are some of the LSBs of the CID.

FIG. 4 illustrates a flow diagram depicting a method for managing allocation of CIDs to the wireless device 102 in the network 100 in accordance with an embodiment of the present invention. The method is initiated at step 402. At step 404, a CID is allocated to the wireless device 102 based on a predefined criteria. The CID is allocated to the wireless device 102 for at least the service accessed by the wireless device 102. The CID includes first predetermined bit locations and second predetermined bit locations. In an embodiment of the present invention, the first predetermined bit locations can be some of the MSBs of the CID and the second predetermined bit locations can be some of the LSBs of the CID. For example, consider a CID of 32 bits. The locations from bit number ‘0’ to bit number ‘12’ can be called the second predetermined bit locations of the CID and locations from bit number ‘20’ to the bit number ‘31’ can be called the first predetermined bit locations of the CID. Thereafter, at step 406, the wireless device 102 may be instructed to be responsive to messages that contain the predetermined bit locations of the CID. In another embodiment of the present invention, the wireless device 102 may be instructed to be responsive to messages that contain the complete CID.

In various embodiments of the present invention, the above-described can be applied to a group of one or more than one wireless devices. In one such embodiment of the present invention, the wireless devices within a same Orthogonal Frequency Division Multiplexing (OFDM) resource assignment group can form the group. In another such embodiment of the present invention, the wireless devices accessing a same service can form the group. For example, the set of wireless devices accessing an internet service can be grouped and the set of wireless devices accessing a voice service can be grouped. In yet another such embodiment of the present invention, the wireless devices located within a given radius from the BTS 110 can be grouped together. For example, the wireless devices that are within a range of 100 meters from the BTS 110 can be grouped together. In still another such embodiment of the present invention, the wireless devices that are geographically close to each other can form the group. In yet another such embodiment of the present invention, the wireless devices that receive signal below pre-specified signal strength can be grouped together to form a group. For example, wireless devices that are located at the edge of a service area of the BTS 110 may receive signals below certain strength and these wireless devices can be grouped together.

The CID is allocated to the wireless devices in the group such that the first predetermined bit locations of the CID of each wireless device is same but the second predetermined bit locations of the CIDs are different. Further, it is ensured that the first predetermined bit locations are different from that of any other wireless device (other that the group). Thus, the group can be identified by the first predetermined bit locations in the CID and the second predetermined bit locations are not required to identify the group. The second predetermined bit locations may then identify individual wireless devices in the group. In an embodiment of the present invention, the group of wireless devices may be identified by the MSBs of the CID, whereas the individual wireless devices in the group of wireless devices may be identified by the LSBs of the CID. Thereafter, the method terminates at step 408. In another embodiment of the present invention, the BTS 110 instructs individual wireless devices in the group of wireless devices to be responsive messages that contain the complete CID.

In an embodiment of the present invention, the predefined criteria includes a current frame offset for the service at the wireless device 102 being equal to a pre-specified packet offset. For example, the wireless device 102 can receive audio packets at a regular interval of 40 milliseconds (ms). If the current frame offset is 40 ms, the predefined criteria is satisfied. If the current frame offset is equal to the pre-specified packet offset, the CID is allocated by setting the first predetermined locations of the CID same as the first predetermined bit locations of CIDs allocated to other wireless that have the same current packet offsets. The second predetermined locations are different from the second predetermined bit locations of the CIDs allocated to the other wireless devices. The wireless device 102 can be uniquely identified by the second predetermined bit locations, and the first predetermined bit locations are not required to identify the wireless device 102. For example, the CID allocated to the wireless device 102 may have MSBs same as the MSBs of the wireless devices that have the same packet offset, but the LSBs of the CID for the wireless device 102 are different from the LSBs of the wireless devices that have the same packet offset. Thus, the wireless device 102 can be uniquely identified by the LSBs. In such an embodiment of the present invention, the predefined criteria may include the current frame offset for the service at the wireless device 102 being equal to a packet offset of a set of wireless devices.

In another embodiment of the present invention, the predefined criteria includes the rate of data traffic at the wireless device 102 being greater than a pre-specified rate of data traffic. For example, the rate of data traffic may be 250 kilobits per second (kbps) and the pre-specified rate of data traffic may be 200 kbps. If the rate of data traffic at the wireless device 102 is greater than the pre-specified rate of data traffic, the BTS 110 configures the wireless device 102 to be identified by the second predetermined bit locations by themselves. The wireless device 102 then can ignore all other bits from the CID. In such an embodiment of the present invention, the second predetermined bit locations of the CID may be the LSBs of the CID. In yet another embodiment of the present invention, the wireless device 102 may cease to be identified by the second predetermined bit locations of the CID when the rate of data traffic at the wireless device 102 falls below the pre-specified rate of data traffic.

In another embodiment of the present invention, the predefined criteria includes a mobility of the wireless device 102 being greater than a pre-specified threshold. In other words, the wireless device 102 may change locations very frequently. This would require the CID to be allocated more frequently. If the wireless device 102 has higher mobility than the pre-specified threshold, then the wireless device 102 may be instructed to be responsive to messages that contain the predetermined bit locations of the CID.

In another embodiment of the present invention, the predefined criteria includes a signal strength at the at least first wireless device being less than a pre-specified signal strength. For example, the wireless device 108 may receive weak signals because of it being located far from the BTS 110. If the signal strength is less than the pre-specified signal strength, the BTS 110 configures the wireless device 108 to be identified by the predetermined bit locations of the CID. In such an embodiment, only the predetermined bit locations may be mentioned in an address field of the data packets that are required to be delivered to the wireless device 108. In yet another embodiment of the present invention, the wireless device 108 may cease to be identified by the second predetermined bit locations of the CID when the signal strength at the wireless device 108 becomes greater than the pre-specified signal strength.

In another embodiment of the present invention, the predefined criteria includes a number of users with within a group being greater than a pre-specified number of users.

In another embodiment of the present invention, the CID allocated to other services accessed by the wireless device 102 are checked and a new CID is allocated by keeping the first predetermined bit locations same as CIDs for other services and by allocating different second predetermined bit locations. The first predetermined bit locations are then used to identify the wireless device 102 and the second predetermined bit locations are used to identify the service to which the data packets are related. For example, the wireless device 102 may send a request to the BTS 110 to access a service. The BTS 110 allocates a CID to the wireless device 102. The CIDs allocated for other services accessed by the wireless device 102 are checked and the CID is allocated such that it has same MSBs but different LSBs. Further, the LSBs can be in sequential order. The wireless device 102 is then identified by using the MSBs of the CIDs and each service is identified by the LSBs of the CID.

In another embodiment of the present invention, the wireless devices in the network 100 may cease to be identified by the predetermined bit locations when the predefined criteria are not satisfied.

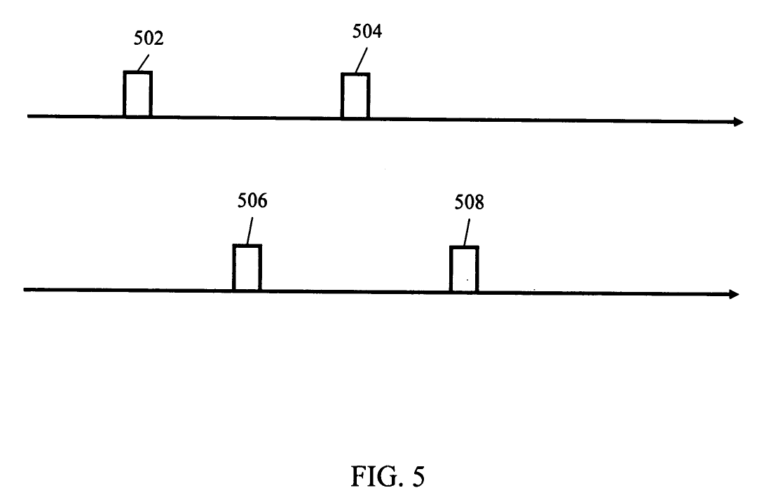

FIG. 5 is a graphical representation of packet offsets for a service accessed by the wireless devices in the network 100 in accordance with an embodiment of the present invention. The wireless devices in the network 100 receive packets at different time intervals or frame offsets from the BTS 110. The X-axis represents frame offsets in milliseconds (ms). At a time instant 502, the wireless device 102 receives packets from the BTS 110. At a time instant 504, the wireless device 104 receives packets from the BTS 110. At a time instant 506, the wireless device 106 receives packets from the BTS 110. At a time instant 508, the wireless device 108 receives packets from the BTS 110. The frame offsets for wireless devices 102 and 104 are the same, whereas the frame offsets for wireless devices 106 and 108 are the same. When the wireless device 104 sends a request to the BTS 110, the BTS 110 compares the current frame offset of the wireless device 104 with a pre-specified packet offset. The BTS 110 then concludes that the current frame offsets of the wireless devices 102 and 104 are the same. The CID allocation is done in such a way that the MSBs of the CID of the wireless device 104 are the same as the MSBs of the CID of wireless device 102. The LSBs of the CID of wireless device 104 are different from the LSBs of the CID of wireless device 102. The wireless device 104 is then instructed to be responsive only to those messages that include LSBs of the CID. Similarly, the wireless devices 106 and 108 have the same current frame offset; hence the LSBs of the CIDs of the wireless device 106 and 108 are different whereas the MSBs are the same.

Various embodiments of the present invention reduce the number of bits of the CID required to identify the wireless devices in the network where doing so creates a disproportionately large system performance benefit. The use of predetermined bit locations to enable a wireless device to receive data packets reduces the use of the whole multi-bit CID. The overall channel overhead in a network is increased. Further, various embodiments of the present invention allocate unambiguous CIDs to wireless devices in the network such that the wireless devices can be identified by a fewer number of bits from the CID. Further, the embodiments of the present invention are also applicable to a group of wireless devices, for example, support the 3GPP2 technology. Moreover, the method as described in the present invention can be applied to all services including Push-to-Talk (PTT), data services, paging services, broadcast services and so forth. Moreover, the embodiments of the present invention enable wireless devices that are located at places with weak signal strength to be identified by a lesser number of bits from the CID, consuming lesser power. Furthermore, the present invention grants a special status, being identified by lesser number of bits from the CID, to wireless devices with higher rate of data traffic or a greater mobility.

It will be appreciated that the method and system for a method and system for managing allocation of connection identifiers (CIDs) to a wireless device in a network described herein may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power source circuits, and user input devices. As such, these functions may be interpreted as steps of a method for managing allocation of CIDs to a wireless device in a network. Alternatively, some or all the functions could be implemented by a state machine that has no stored program instructions, or in one or more application-specific integrated circuits (ASICs), in which each function, or some combinations of certain of the functions, are implemented as custom logic. Of course, a combination of the two approaches could also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for managing allocation of connection identifiers (CIDs) to at least one wireless device in a network, the network providing a plurality of services to the at least one wireless device, the method comprising:
allocating a CID to at least first wireless device based on a predefined criteria, the CID being allocated for at least one of the at least one service that is accessed by the at least first wireless device; and
instructing the at least first wireless device to be responsive to messages containing predetermined bit locations of the CID, the predetermined bit locations comprising a first predetermined bit locations and a second predetermined bit locations.

2. The method as recited in claim 1, wherein the first predetermined bit locations are Most Significant Bits (MSBs) of the CID and the second predetermined bit locations are Least Significant Bits (LSBs) of the CID.

3. The method as recited in claim 1, wherein the at least first wireless device is a group of wireless devices, wherein the group of wireless devices are selected based on at least one of the following: wireless devices within a OFDM resource assignment group, wireless devices accessing a service, wireless devices in geographical proximity, wireless devices receiving signal strength less than a threshold signal strength, and wireless devices in proximity of a network element in the network.

4. The method as recited in claim 3, wherein instructing the at least first wireless device comprises:
instructing the group of wireless devices to be responsive to messages containing the first predetermined bit locations of the CID, the value in the first predetermined bit locations of the group of wireless devices being different from the values in the predetermined bit locations of other CIDs allocated in the network; and
instructing each wireless device of the group of wireless devices to be responsive to messages containing the second predetermined bit locations of the CID.

5. The method as recited in claim 1 further comprising:
allocating a plurality of CIDs to the at least first wireless device for a plurality of service accessed by the at least first wireless device such that the first predetermined bit locations of the plurality of CIDs are same; and
instructing the at least first wireless device to be responsive to messages containing the first predetermined bit locations of the plurality of CIDs.

6. The method as recited in claim 1, wherein the predefined criteria comprises a current frame offset of a service for the at least first wireless device being equal to a pre-specified packet offset.

7. The method as recited in claim 6, wherein allocating the CID to the at least first wireless device comprises setting the predetermined bit locations of the CID of the at least first wireless device, wherein the second predetermined bit locations of the CID are different from the second predetermined bit locations of CID allocated to a set of wireless devices, and wherein the first predetermined bit locations of CID are same as the first predetermined bit locations of the CID allocated to the set of wireless devices.

8. The method as recited in claim 6, wherein allocating the CID to the at least first wireless device comprises setting the predetermined bit locations of the CID of the at least first wireless device, wherein the second predetermined bit locations of the CID are different from the second predetermined bit locations of CID allocated to a set of wireless devices with the current frame offset equal to the pre-specified packet offset, and wherein the first predetermined bit locations of CID are same as the first predetermined bit locations of the CID allocated to the set of wireless devices.

9. The method as recited in claim 1, wherein the predefined criteria comprises a rate of data traffic at the at least first wireless device being greater than a pre-specified rate of data traffic.

10. The method as recited in claim 9, wherein instructing the at least first wireless device comprises configuring the at least first wireless device to be identified by the second predetermined bit locations of the CID when the rate of data traffic at the at least first wireless device is greater than the pre-specified rate of data traffic.

11. The method as recited in claim 10, wherein the at least first wireless device ceases to be identified by the second predetermined bit locations of the CID when the rate of data traffic at the at least first wireless device is less than the pre-specified rate of data traffic.

12. The method as recited in claim 1, wherein the predefined criteria comprises signal strength at the at least first wireless device being less than a pre-specified signal strength.

13. The method as recited in claim 12, wherein instructing the at least first wireless device comprises configuring the at least first wireless device to be identified by the second predetermined bit locations of the CID when the signal strength at the at least first wireless device is less than the pre-specified signal strength.

14. The method as recited in claim 13, wherein the at least first wireless device ceases to be identified by the second predetermined bit locations of the CID when the signal strength at the at least first wireless device becomes greater than the pre-specified signal strength.

15. The method as recited in claim 1, wherein the predefined criteria comprises a mobility of the at least first wireless device being greater than a pre-specified threshold.

16. The method as recited in claim 15, wherein instructing the at least first wireless device comprises configuring the at least first wireless device to be identified by the second predetermined bit locations of the CID when the mobility of the at least first wireless device is greater than the pre-specified threshold.

17. The method as recited in claim 1, wherein the predefined criteria comprises number of users within a group being greater than a pre-specified number of users.

18. The method of claim 1 wherein the at least first wireless device ceases to be responsive to messages containing only the predetermined bit locations of the CID when the predefined criteria are not satisfied.

19. The method as recited in claim 1, wherein the network is a current sector of the at least one wireless device in the network.

20. A wireless device in a network, the wireless device comprising:
a receiver capable of receiving a set of instruction from the network, wherein the set of instructions are sent with a CID allocated based on a predefined criteria; and
a processor configured to interpret the set of instructions from the network enabling the wireless device to be responsive to messages containing predetermined bit locations of a connection identifier (CID), the predetermined bit locations comprising a first predetermined bit locations and a second predetermined bit locations.

21. The wireless device as recited in claim 20, wherein the first predetermined bit locations are Most Significant Bits (MSBs) of the CID and the second predetermined bit locations are Least Significant Bits (LSBs) of the CID.

22. The wireless device as recited in claim 20 further comprising a transmitter capable of transmitting a request to access a service in the network.

23. A Base Transceiver Station (BTS) in a network, the BTS comprising:
a processor capable of allocating a connection identifier (CID) to at least first wireless device based on a predefined criteria, the CID being allocated for each of at least one service accessed by the at least first wireless device;
a comparator configured to perform the predefined criteria by comparing at least one of:
a current frame offset of the at least first wireless device with a pre-specified packet offset;
the number of users in a group of wireless devices with a pre-specified threshold;
a mobility of the at least first wireless device with a pre-specified threshold;
a rate of data traffic at the at least first wireless device with a pre-specified rate of data traffic; and
a signal strength at the at least first wireless device with a pre-specified signal strength; and
a transmitter capable of instructing the at least first wireless device to be responsive to messages containing predetermined bit locations of the CID, the predetermined bit locations comprising a first predetermined bit locations and a second predetermined bit locations.
